(19) United States
(12) Patent Application Publication
(10) Pub. No.: US 2020/0117763 A1
(43) Pub. Date: Apr. 16, 2020

(54) RELATIONAL INTERVAL TREE WITH DISTINCT BORDERS

(71) Applicant: CA, Inc., Islandia, NY (US)

(72) Inventor: Rostislav Julinek, Benatky nad Jizerou (CZ)

(73) Assignee: CA, Inc., Islandia, NY (US)

(21) Appl. No.: 16/160,349

(22) Filed: Oct. 15, 2018

(51) Int. Cl. G06F 17/30

(52) U.S. Cl. CPC G06F 17/30979; G06F 17/30961

(57) ABSTRACT

In one embodiment, a searchable interval associated with a database is defined, and an interval tree corresponding to the searchable interval is generated. The interval tree comprises a plurality of interval nodes arranged in a plurality of tiers, wherein the plurality of interval nodes correspond to a plurality of tree intervals that collectively span the searchable interval, and wherein the plurality of tree intervals comprise interval boundaries that are distinct among the plurality of tiers. A database query comprising an interval query parameter is then received, and one or more responsive data records corresponding to the database query are identified, wherein the one or more responsive data records are identified from a plurality of data records in the database based on the interval tree and the interval query parameter. The one or more responsive data records are then retrieved from the database, and a response to the database query is generated based on the one or more responsive data records.

### BACKGROUND

This disclosure relates in general to the field of data processing and storage, and more particularly, though not exclusively, to database management using relational interval trees with distinct boundaries.

A database typically includes a collection of data records with various fields containing the respective attributes of each data record. Further, database indexes are often created to enable certain fields of the database to be queried more efficiently. It can be challenging, however, to efficiently query a database based on fields within the database that contain intervals.

### BRIEF SUMMARY

According to one aspect of the present disclosure, a searchable interval associated with a database is defined, and an interval tree corresponding to the searchable interval is generated. The interval tree comprises a plurality of interval nodes arranged in a plurality of tiers, wherein the plurality of interval nodes correspond to a plurality of tree intervals that collectively span the searchable interval, and wherein the plurality of tree intervals comprise interval boundaries that are distinct among the plurality of tiers. A database query comprising an interval query parameter is then received, and one or more responsive data records corresponding to the database query are identified, wherein the one or more responsive data records are identified from a plurality of data records in the database based on the interval tree and the interval query parameter. The one or more responsive data records are then retrieved from the database, and a response to the database query is generated based on the one or more responsive data records.

### BRIEF DESCRIPTION OF THE DRAWINGS

FIG. 1 illustrates an example embodiment of a computing system for processing database queries using relational interval trees with distinct boundaries.

FIG. 2 illustrates an example flowchart for generating a relational interval tree with distinct boundaries.

FIG. 3 illustrates an example flowchart for processing database queries using a relational interval tree with distinct boundaries.

FIG. 4A illustrates an example of a relational interval tree with distinct boundaries.

FIG. 4B illustrates an example of a relational interval tree with colliding boundaries.

FIGS. 5A-D illustrate different relational interval trees associated with an example use case.

### DETAILED DESCRIPTION OF EXAMPLE EMBODIMENTS

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

Example embodiments that may be used to implement the features and functionality of this disclosure will now be described with more particular reference to the attached FIGURES.

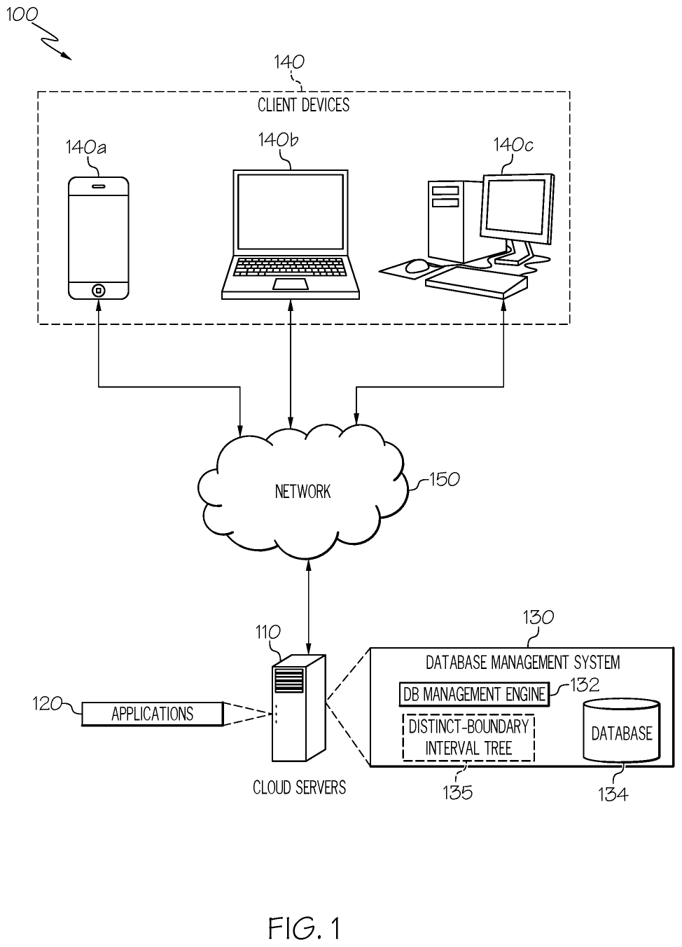

FIG. 1 illustrates an example embodiment of a computing system 100 for processing database queries using relational interval trees with distinct boundaries.

In the illustrated embodiment, for example, computing system 100 includes cloud-based servers and/or mainframes 110, client devices 140a-c, and one or more networks 150. Cloud servers 110 include one or more computing applications 120 and a database management system (DBMS) 130. Computing applications 120 and database management system (DBMS) 130 may be executed on one or more processors within cloud servers 110, and their underlying data (e.g., databases 134 and/or interval trees 135) may be stored on one or more memory components and/or data storage devices within cloud servers 110. Client devices 140a-c can include any type of device that communicates or interacts with cloud servers 110, such as mobile devices, laptops, desktops, kiosks, and/or other datacenter servers, mainframes, or processing devices. Moreover, components of computing system 100—such as cloud servers 110 and client devices 140—may communicate with each other over network 150. Database management system (DBMS) 130 includes a database management engine 132, along with one or more databases 134, and one or more relational interval trees 135 with distinct boundaries. Database management engine 132 manages access to the databases 134, which includes processing and responding to database queries that are received from applications 120 and/or client devices 140. Moreover, database management engine 132 uses interval trees 135 with distinct boundaries to process interval queries more efficiently, as described further below.

Large enterprises, such as businesses and other organizations, typically generate and/or consume massive volumes of data throughout the ordinary course of business. For example, a business often runs a variety of computing applications that are designed to facilitate or streamline regular business operations, such as applications that provide certain services for the benefit of customers, employees, and/or the business itself. These types of computing applications generally consume and/or generate large volumes of data throughout the course of their operation. Further, numerous reports associated with this data are often generated by a business on a regular basis. In this manner, large volumes of database queries are continuously received from various sources that need access to certain data and/or reports, such as applications, system administrators, employees, customers, and so forth. Accordingly, enterprises must be capable of processing database queries in an efficient manner.

A database typically includes a collection of data records with various fields containing the respective attributes of each data record. Moreover, database indexes are often created to enable certain fields of the database to be queried more efficiently. It can be challenging, however, to efficiently query the database based on fields that contain intervals. For example, in some cases, the database may include fields that store certain types of intervals associated with the data records, such as time intervals, geographical or distance intervals, financial intervals, and/or any other type of numerical interval.

For example, time-series data typically contains data records that each have a defined validation interval, such as a start_time and end_time. Moreover, queries for these data records may specify a ‘time’ property, which can be used to identify valid or responsive data records that match the following search criteria:

rec.start_time<=‘time’

AND ‘time’<rec.end_time

However, this type of query may require a full scan of the database since the condition only requires a partial match (e.g., less than or equal) rather than an exact match (e.g., equal).

Accordingly, in some cases, a relational interval tree (RIT) may be leveraged to process interval queries more efficiently. A relational interval tree, however, typically has collisions among the node boundaries of different tiers, which can result in poor performance in certain circumstances. Accordingly, this disclosure presents various embodiments of relational interval trees with distinct boundaries, which greatly improve the speed of interval queries, while also eliminating the performance drawbacks associated with interval trees whose boundaries collide across different tiers.

For example, a relational interval tree can be implemented using the following methods, where the input arguments can be integers, longs, or timestamps (e.g., for time-series data):

int getFork(startValue, endValue)

int[]getForksForValue(value)

The getFork( ) method is used for storing data records in a database—its input arguments represent an interval associated with a particular data record, while its output represents a corresponding “fork” node in an interval tree, which is stored or referenced in an indexed field of the data record for the purpose of responding to interval queries.

The getForksForValue( ) method is used for responding to interval queries—its input argument is an interval value associated with a search parameter from an interval query, while its output is an array of all possible fork values from the interval tree that may contain data records with matching intervals.

The relationship between these methods can be represented as follows:

getForksForValue(value) CONTAINS getFork(startValue, endValue)

in case that value IS BETWEEN startValue AND endValue.

Accordingly, an interval query associated with these data records can be enriched using a fork lookup:

rec.fork IN getForksForValue('time')

AND rec.start_time<=‘time’

AND ‘time’<rec.end_time

In this manner, assuming rec.fork is an indexed field, a subset of the data records is initially preselected based on the potential fork values, and that subset of data records is then evaluated one-by-one to identify matching records with an appropriate start_time and end_time.

This usage applies regardless of whether the underlying relational interval tree has colliding boundaries or distinct boundaries, as the primary difference between those types of interval trees is based on how the getFork( ) and getForksForValue( ) methods are implemented. For example, as discussed further below, an interval tree with distinct boundaries provides a more uniform distribution of fork values used to cache the data records, which reduces the number of data records that are preselected and checked one-by-one when responding to interval queries.

Additional details and embodiments associated with distinct-boundary relational interval trees are described throughout this disclosure in connection with the remaining FIGURES.

In general, elements of computing system 100, such as “systems,” “servers,” “mainframes,” “devices,” “clients,” “networks,” “computers,” and any components thereof, may be used interchangeably herein and refer to computing devices operable to receive, transmit, process, store, or manage data and information associated with computing system 100. Moreover, as used in this disclosure, the term “computer,” “processor,” “processor device,” or “processing device” is intended to encompass any suitable processing device. For example, elements shown as single devices within computing system 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Moreover, elements of computing system 100 (e.g., cloud servers 110, applications 120, database management system 130, client devices 140a-c, network 150, and so forth) may each include one or more processors, computer-readable memory, and one or more communication interfaces, among other features and hardware. Servers and mainframes may include any suitable software component or module, or computing device(s) capable of hosting and/or serving software applications and services, including distributed, enterprise, or cloud-based software applications, data, and services. For instance, one or more of the described components of computing system 100 may be at least partially (or wholly) cloud-implemented, “fog”-implemented, web-based, or distributed for remotely hosting, serving, or otherwise managing data, software services, and applications that interface, coordinate with, depend on, or are used by other components of computing system 100. In some instances, elements of computing system 100 may be implemented as some combination of components hosted on a common computing system, server, server pool, or cloud computing system, and that share computing resources, including shared memory, processors, and interfaces.

Further, the network(s) 150 used to communicatively couple the components of computing system 100 may be implemented using any suitable computer communication or network technology for facilitating communication between the participating components. For example, one or a combination of local area networks, wide area networks, public networks, the Internet, cellular networks, Wi-Fi networks, short-range networks (e.g., Bluetooth or ZigBee), and/or any other wired or wireless communication medium may be utilized for communication between the participating devices, among other examples.

While FIG. 1 is described as containing or being associated with a plurality of elements, not all elements illustrated within computing system 100 of FIG. 1 may be utilized in each alternative implementation of the embodiments of this disclosure. Additionally, one or more of the elements described in connection with the examples of FIG. 1 may be located external to computing system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Additional embodiments and functionality associated with the implementation of computing system 100 are described further in connection with the remaining FIGURES. Accordingly, it should be appreciated that computing system 100 of FIG. 1 may be implemented with any aspects or functionality of the embodiments described throughout this disclosure.

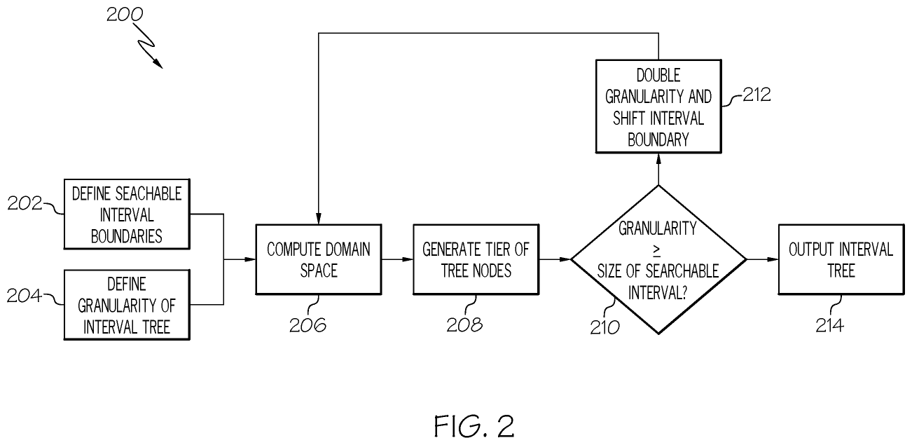

FIG. 2 illustrates an example flowchart 200 for generating a relational interval tree with distinct boundaries. In various embodiments, for example, flowchart 200 may be implemented using the devices and functionality described throughout this disclosure (e.g., computing system 100 and/or database management system 130 of FIG. 1).

The flowchart may begin at block 202 by defining the boundaries of the searchable interval associated with the interval tree. In particular, the minimum and maximum values of the searchable interval are defined up front in order to limit the size and scope of the interval tree. For example, with respect to time-series data (e.g., data associated with temporal intervals), the minimum time could be set to Jan. 1, 1970 (e.g., the beginning of UNIX epoch time) and the maximum time could be set to Dec. 31, 2200 (e.g., an arbitrary time in the future). This will enable data records to be stored and searched over a 230-year time period using the interval tree.

The flowchart may then proceed to block 204 to define the minimum granularity of the interval tree. In particular, the interval tree algorithm needs to define a minimum fork granularity, which represents the maximum distance of interval values that produces the same result for getForksForValue(value). Low granularity means that a single fork node will be used to store more data records, while high granularity means that getForksForValue(value) will return more fork nodes for the subsequent search of the indexed data records. The optimal choice for granularity depends on the typical interval size associated with the data records. In some embodiments, the optimal granularity can be determined based on performance tests, machine learning analysis, and so forth. The decision about granularity is defined up front.

The flowchart may then proceed to block 206 to compute a domain space based on the searchable interval (block 202) and the minimum granularity (block 204). For example, assuming the minimum interval boundary is defined as Jan. 1, 1970, the maximum interval boundary is defined as Dec. 31, 2200, and the minimum granularity is defined as one hour, then the corresponding domain space has a size of 2,014,800 values, which represents the number of hours in 230 years. With respect to a particular domain space, the ‘domain-value’ of any given ‘value’ within the searchable interval is defined as

$$\frac{( value - minimum )}{granularity} .$$

If the difference between two interval values is greater than defined granularity, those interval values have different domain-values. The collection of all domain-values in the domain space are in the interval from

$$[ 0 , \frac{( maximum - minimum )}{granularity} ] .$$

The flowchart may then proceed to block 208 to generate a tier of nodes in the interval tree based on the computed domain space (block 206). In particular, each tier of interval nodes is generated based on a particular domain space, and each interval node in a given tier corresponds to one of the domain-values in that domain space. Moreover, a ‘tierN-value’ is assigned to each interval node in a given tier based on its corresponding domain-value. The tierN-value is a simple mapping of the domain-value in order to avoid collisions among the values assigned to interval nodes of different tiers. In this manner, each interval node in the resulting tree will be assigned with a unique value that serves as its corresponding “fork” node value. In some embodiments, for example, the tierN-value could be defined as tierN-value=domain-value*2^{N}+N, where N represents the number of the associated tier. In other embodiments, however, any type of mapping can be used that avoids collisions of the interval node values across different tiers (e.g., shifting the domain-values in each tier by the maximum value of the corresponding domain space).

Each successive tier of interval nodes is generated in the manner described above but using a different domain space. In particular, the domain space for each successive tier is computed by doubling the prior granularity and shifting the minimum interval boundary by half of the prior granularity. Successive tiers of interval nodes are continuously generated in this manner until the granularity of the domain space for a generated tier equals or exceeds the size of the defined searchable interval.

For example, during the initial iteration of block 208, a 1^{st} tier of interval nodes is generated based on the initial domain space (e.g., block 206) computed from the searchable interval and granularity that were originally defined at the outset (e.g., blocks 202, 204). In particular, the initial domain space was computed over an interval from Jan. 1, 1970-Dec. 31, 2200 using a granularity of one hour, resulting in a domain space of 2,014,800 values. Accordingly, each interval node in the 1^{st} tier corresponds to a particular domain-value in that domain space. Further, based on the tierN mapping described above, each interval node in the 1^{st} tier is assigned with a tier1-value computed as tier1-value=domain-value*2+1, which effectively maps the domain-values to odd numbers.

The 2^{nd} tier is generated using a different domain space than the 1^{st} tier. As described above, for example, the domain space for the 2^{nd} tier is computed by shifting the minimum interval boundary by half of the granularity (e.g., 0.5 hours) and doubling the granularity (2 hours). Thus, the minimum interval boundary is now Dec. 31, 1969 at 23:30, the maximum interval boundary remains the same, and the granularity is 2 hours. Accordingly, the domain space for the 2^{nd} tier is computed over the interval from Dec. 31, 1969 at 23:30-Dec. 31, 2200 using a granularity of two hours, resulting in a domain space of 1,007,400 values. Further, each interval node in the 2^{nd} tier is assigned with a tier2-value computed as tier2-value=domain-value*4+2, which effectively maps the domain-values to numbers divisible by two but not four.

Successive tiers are continuously generated in this manner until the granularity of a generated tier covers the entire searchable interval (e.g., the [minimum, maximum] range defined at block 202). In this example, the 22^{nd} tier will have a granularity of 2,097,152 hours (239 years), which is just larger than the size of the original searchable interval (230 years).

Thus, during each iteration of the algorithm, a domain space is computed (block 206) and a tier of interval nodes is generated based on the domain space (block 208). The flowchart then proceeds to block 210 to determine whether the granularity associated with the current tier equals or exceeds the size of the searchable interval. If the granularity is less than the size of the searchable interval, the minimum interval boundary is shifted by half the granularity and the granularity is doubled (block 212), a new domain space is computed (block 206), and a successive tier of interval nodes is generated based on the new domain space (block 208).

The flowchart may continue cycling through blocks 206-212 in this manner to generate successive tiers of interval nodes—with each successive tier corresponding to a domain space with a doubled granularity and shifted domain interval—until the granularity of a generated tier equals or exceeds the size of the defined searchable interval.

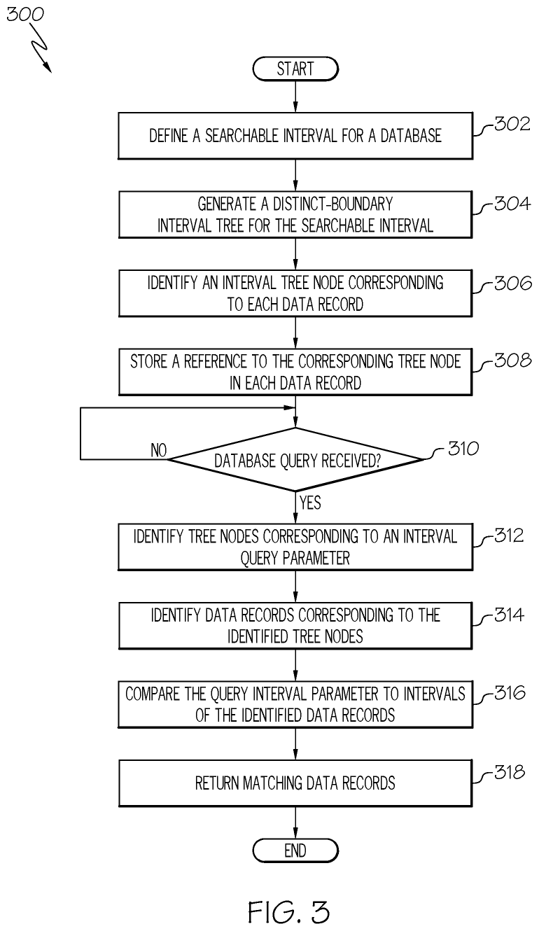

Once it is determined at block 210 that the granularity of the current tier equals or exceeds the size of the searchable interval, no further tiers need to be generated, and the flowchart proceeds to block 214 to output the resulting interval tree. The resulting interval tree can then be used to process interval-based database queries in an efficient manner (e.g., as described further below in connection with FIG. 3).

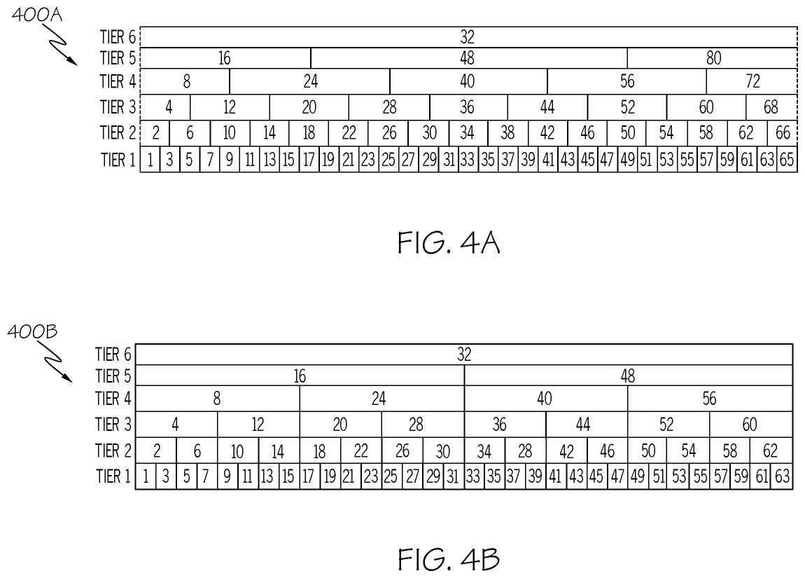

Notably, the resulting interval tree generated using the approach described above has distinct boundaries among the nodes of different tiers. By way of example, an interval tree generated using the approach described above is visualized in FIG. 4A. In particular, FIG. 4A illustrates the tierN-values for six tiers of the interval tree. As depicted by FIG. 4A, the granularity is doubled in each tier and the minimum interval boundary is shifted by half of the prior granularity, and as a result, the nodes in different tiers have distinct boundaries.

For comparison, an interval tree with colliding boundaries among the nodes of different tiers is visualized in FIG. 4B. In particular, the interval tree of FIG. 4B is a binary tree with tiers of fork nodes whose granularities double in each tier. However, all tiers of the tree are computed using the exact same interval (e.g., without shifting the minimum interval boundary for each tier), which results in numerous collisions among the boundaries of nodes from different tiers.

To illustrate the difference between the interval trees of FIGS. 4A and 4B, consider a data record with a corresponding interval of [47, 50]. In each interval tree, the fork node corresponding to that data record is the fork node in the lowest tier of the tree that covers both the starting boundary (47) and the ending boundary (50) of the interval [47, 50]. This corresponding fork node can be identified by calling the getFork(startValue, endValue) method, which translates to getFork(47,50) for the particular interval in this example.

With respect to the interval tree of FIG. 4B, for example, the corresponding fork node for interval [47, 50] is fork node 48 from the 5^{th} tier of the tree. This is because the 5^{th} tier is the lowest tier in which the startValue (47) and endValue (50) share the same fork node—they do not share the same fork node in any lower tiers. For example, in each tier below the 5^{th} tier, the fork node of the startValue (47) is different from the fork node of the endValue (50). This is because the relevant fork nodes in the 1^{st}-4^{th} tiers all share a common boundary that falls within the corresponding interval of [47, 50], which means the startValue (47) and endValue (50) of the interval are split into different fork nodes in those tiers. For example, the following fork nodes from the 1^{st}-4^{th} tiers all share a common boundary:

tier 1: fork nodes 47, 49;

tier 2: fork nodes 46, 50;

tier 3: fork nodes 44, 52; and

tier 4: fork nodes 40, 56.

As a result, the 5^{th} tier is the lowest tier in which the startValue (47) and endValue (50) share the same fork node, which is fork node 48. Thus, even though the interval [47, 50] only has a size of three, it is stored on the 5^{th} tier of the interval tree, which has a granularity of 32. This means that tiers of the interval tree with large granularities will contain data records with much smaller intervals in some cases, which increases the number of data records that have to be searched one-by-one for those tiers (even when the interval is very small).

On the other hand, with respect to the interval tree of FIG. 4A, the corresponding fork node for interval [47, 50] is fork node 52 from the 3^{rd} tier of the tree, which has a granularity of eight. For example, even though an interval of size three could potentially fit into a fork node within the 2^{nd} tier (since that tier has a granularity of four), the particular interval in this example ([47, 50]) spans the border between two fork nodes in the 2^{nd} tier (e.g., nodes 46 and 50), so instead it falls up one tier to a node in the 3^{rd} tier (e.g., fork node 52). Thus, the corresponding fork node for any given interval will fall in either the lowest tier whose granularity exceeds the interval size, or one tier up, but never any higher. This is because the fork nodes in each tier have distinct boundaries relative to those in other tiers.

Thus, due to the distinct boundaries among the tiers in the interval tree of FIG. 4A, data records with small intervals are always placed in lower tiers with small granularities. In this manner, if all (or most) of the data records in a database have small intervals, the higher tiers of the interval tree will simply remain unused, which means there will be no reduction in performance if the interval tree has a large number of tiers. Accordingly, since the number of tiers of the interval tree does not impact performance, there is more flexibility in the initial selection of parameters used to generate the interval tree, such as the boundaries of the searchable interval and the minimum granularity.

On the other hand, with respect to the interval tree of FIG. 4B, the boundary collisions among tiers can cause data records with small intervals to be placed in higher tiers with large granularities in some circumstances. As a result, the higher tiers may contain a mix of data records with both large and small intervals, while the lower tiers may only contain some data records with small intervals. Thus, more data records are distributed in the higher tiers than in the lower tiers, which means there are more data records that must be checked one-by-one when responding to interval queries that involve the higher tiers.

Example code for implementing a relational interval tree with distinct boundaries is provided below in Appendix A, which is fully incorporated by reference into this disclosure. The example code is written in the Java programming language.

In the example code, the interval tree is a precomputed table represented as an array of tier data structures, where each tier data structure in the array defines a particular tier of the tree. Thus, the number of elements in the array is equivalent to the number of tiers in the interval tree, which is a small memory footprint. Accordingly, the interval tree requires only nominal additional memory overhead in exchange for significantly improving the response time for interval queries.

The example code includes implementations of the getFork( ) and getForksForValue( ) methods (which are discussed above):

int getFork(startValue, endValue)

int[] getForksForValue(value)

The getFork(startValue, endValue) method returns the tierN-value for ‘startValue’ and ‘endValue’ from the lowest tier (e.g., the lowest value of N) in which those parameters are mapped to the same tierN-value. This method can be optimized to only search tiers whose corresponding granularity is larger than the difference between the ‘startValue’ and ‘endValue’ parameters.

The getForksForValue(value) method returns an array of all tierN-values corresponding to the ‘value’ parameter. Accordingly, the number of elements in the resulting array is equivalent to the number of tiers in the interval tree. The number of tiers in the interval tree, and thus the size of the resulting array returned by this method, are dictated by the size of the searchable interval and minimum granularity that are defined at the outset.

The attributes of the interval tree generated by the example code in Appendix A are shown below in TABLE 1. In the example code, the interval tree is generated based on a searchable interval of 239 years (e.g., starting from the beginning of UNIX Epoch time) and a minimum granularity of 15 minutes, which results in an interval tree with 24 tiers. Accordingly, the interval tree is represented by an array of tier data structures that contains 24 elements, each of which corresponds to a particular tier of the interval tree. The fork values do not start at value 1 in order to avoid using negative numbers during the pre-calculations—the starting value does not matter since the numbers are still 32-bit integers.

TABLE 1
Attributes of interval tree generated by example code from Appendix A

| | FORK | | | GRANULARITY |
|---|---|---|---|---|
| TIER | minimum | maximum | step | (hours) |
| 1 | 16777217 | 33526337 | 2 | 0.25 |
| 2 | 16777218 | 33526338 | 4 | 0.5 |
| 3 | 16777220 | 33526340 | 8 | 1 |
| 4 | 16777224 | 33526344 | 16 | 2 |
| 5 | 16777232 | 33526352 | 32 | 4 |
| 6 | 16777248 | 33526368 | 64 | 8 |
| 7 | 16777280 | 33526336 | 128 | 16 |
| 8 | 16777344 | 33526400 | 256 | 32 |
| 9 | 16777472 | 33526528 | 512 | 64 |
| 10 | 16777728 | 33526272 | 1024 | 128 |
| 11 | 16778240 | 33526784 | 2048 | 256 |
| 12 | 16779264 | 33527808 | 4096 | 512 |
| 13 | 16781312 | 33525760 | 8192 | 1024 |
| 14 | 16785408 | 33529856 | 16384 | 2048 |
| 15 | 16793600 | 33538048 | 32768 | 4096 |
| 16 | 16809984 | 33521664 | 65536 | 8192 |
| 17 | 16842752 | 33488896 | 131072 | 16384 |
| 18 | 16908288 | 33423360 | 262144 | 32768 |
| 19 | 17039360 | 33292288 | 524288 | 65536 |
| 20 | 17301504 | 33030144 | 1048576 | 131072 |
| 21 | 17825792 | 32505856 | 2097152 | 262144 |
| 22 | 18874368 | 29360128 | 4194304 | 524288 |
| 23 | 20971520 | 31457280 | 8388608 | 1048576 |
| 24 | 25165824 | 25165824 | 16777216 | 2097152 |

FIG. 3 illustrates an example flowchart 300 for processing database queries using a relational interval tree with distinct boundaries. In some embodiments, flowchart 300 may be implemented using the embodiments and functionality described throughout this disclosure (e.g., computing system 100 and/or database management system 130 of FIG. 1).

The flowchart may begin at block 302 by defining a searchable interval associated with a database on a data storage device. In some embodiments, for example, the searchable interval may be defined or selected such that the data records within the database all have corresponding data intervals that are within the defined searchable interval.

The flowchart may then proceed to block 304 to generate an interval tree corresponding to the searchable interval. In some embodiments, for example, the interval tree may be generated using the approach described above in connection with FIG. 2. In this manner, the resulting interval tree will have distinct boundaries among the nodes of different tiers. For example, the interval tree may include a plurality of interval nodes arranged in a plurality of tiers. The interval nodes may correspond to a plurality of tree or fork intervals that collectively span the searchable interval and further contain interval boundaries that are distinct among the plurality of tiers. In some embodiments, for example, the interval tree may be generated by shifting the minimum interval boundary and doubling the granularity for each successive tier of the tree.

Moreover, the interval tree may be represented in memory using any suitable data structure(s), including arrays, linked lists, and so forth. Further, in some embodiments, other types of graph-based structures may be used instead of an interval tree.

The flowchart may then proceed to block 306 to identify an interval tree node corresponding to each database record, and then to block 308 to store a reference to the corresponding tree node in each database record.

The flowchart may then proceed to block 310 to determine whether a database query has been received. If no database query has been received, the flowchart remains at block 310 until a query is received.

Once a database query has been received, the flowchart may then proceed to block 312 to identify tree nodes corresponding to an interval parameter in the query.

The flowchart may then proceed to block 314 to identify database records corresponding to the identified tree nodes.

The flowchart may then proceed to block 316 to compare intervals of the identified database records to the query interval parameter.

Finally, the flowchart may then proceed to block 318 to return the matching database records.

At this point, the flowchart may be complete. In some embodiments, however, the flowchart may restart and/or certain blocks may be repeated. For example, in some embodiments, the flowchart may repeat blocks 310 to 318 to continue receiving and processing database queries. Alternatively, or additionally, the flowchart may restart at block 302 to continue defining searchable intervals, generating interval trees, and processing interval queries for other databases.

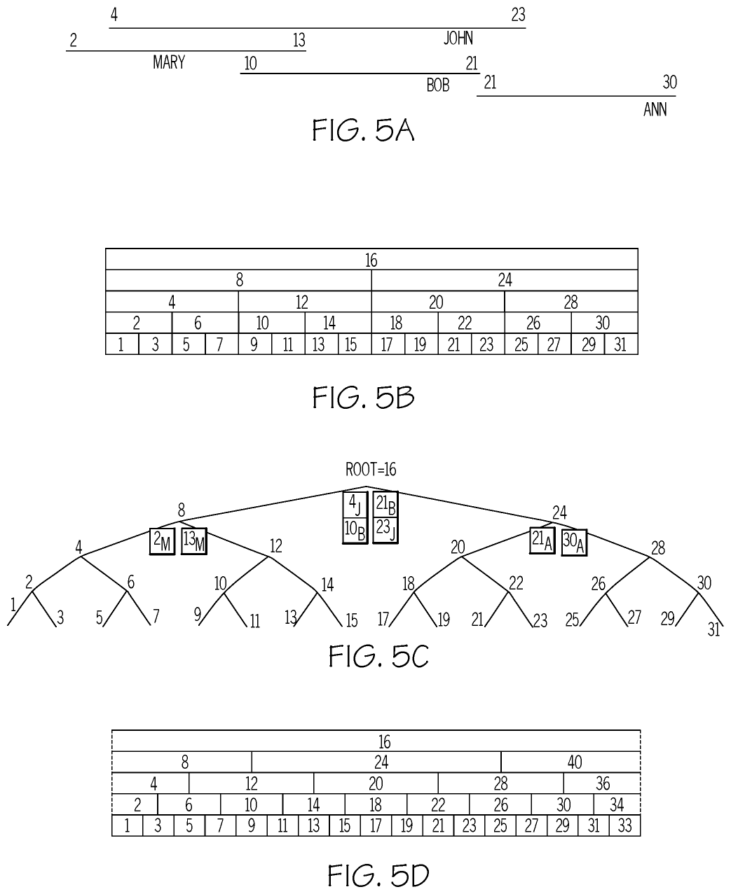

FIGS. 5A-D illustrate different relational interval trees associated with an example use case. In particular, FIG. 5A depicts various data records that contain intervals associated with different people, while FIGS. 5B-D illustrate different interval trees that can be used to search those data records. For example, FIGS. 5B-C depict an interval tree with node boundaries that collide across different tiers, while FIG. 5D depicts an interval tree with node boundaries that are distinct across different tiers. Compared to the interval tree of FIGS. 5B-C, the node boundaries of the interval tree of FIG. 5D have been shifted in each tier, which eliminates the collisions among node boundaries of different tiers. In this manner, the interval tree of FIG. 5D provides a better distribution of data records than that of FIGS. B-C due to its distinct node boundaries across tiers, which can significantly improve the response time for interval queries processed using the interval tree. Further, the interval tree of FIG. 5D can be generated using the approach described throughout this disclosure. For example, the interval tree of FIG. 5D can be generated by shifting the minimum interval boundary by half the granularity and doubling the granularity for each successive tier of the interval tree.

It should be appreciated that the flowcharts and block diagrams in the FIGURES illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

APPENDIX A
EXAMPLE CODE

public class ForkImpl {

static final long GRANULARITY = 15 * 60 * 1000L; // 15 minutes
static final long MINIMAL_VALUE = 0; // beginning of epoch
// 239 years - exactly fits to 24 tiers
public static final long MAXIMAL_VALUE = MINIMAL_VALUE + 239L * 365 * 24 * 60 * 60 *

1000L;

static class TierData {

int startFork;
final int level;
final int step;
final long startTime;
final long forkRange;
private TierData(long forkRange, int step, int level) {

long midTime = MINIMAL_VALUE + (MAXIMAL_VALUE − MINIMAL_VALUE) / 2;
this.forkRange = forkRange;
this.step = step;
this.level = level;
long midBorder = midTime − (forkRange / 2);
int midFork = (int)((midTime / forkRange) * step * step / step + step / 2);
for (; midBorder > MINIMAL_VALUE; midBorder −= forkRange) {

midFork −= step;

}
this.startFork = midFork;
this.startTime = midBorder;

}
void shiftStart(int shift) {

this.startFork += shift;

}
public boolean isLastTier( ) {

return this.startTime + this.forkRange >= MAXIMAL_VALUE;

}
public int getFork(long time) {

long diff = time − this.startTime;
int fork = ((int) (diff / this.forkRange)) * this.step + this.startFork;
return fork;

}

}
static TierData[ ] preCalculated;
static {

List<TierData> result = new ArrayList<TierData>( );
TierData last = new TierData(GRANULARITY, 2, 1);
result.add(last);
boolean needShift = false;
while (!last.isLastTier( )) {

TierData item = new TierData(last.forkRange * 2, last.step * 2, last.level + 1);
result.add(item);
last = item;
if (0 > last.startFork) {

needshift = true;

}

}
if (needShift) {

for (TierData item : result) {

item.shiftStart(last.step);

}

}
preCalculated = new TierData[result.size( )];
result.toArray(preCalculated);

}
public int getFork(long startValue, long endValue) {

long diff = endValue − startValue;
for (TierData tier : preCalculated) {

if (tier.forkRange < diff) {

continue;

}
int startFork = tier.getFork(startValue);
int endFork = tier.getFork(endValue);
if (startFork == endFork) {

return startFork;

}

}
throw new IllegalStateException(“Fork computation is not properly initialized.”);

}
public int[ ] getForksForValue(long value) {

int[ ] result = new int[preCalculated.length];
int ndx = 0;
for (TierData tier : preCalculated) {

result[ndx++] = tier.getFork(value);

}
return result;

}

}

1. A method, comprising:
defining a searchable interval associated with a database stored on a data storage device, wherein the database is to store a plurality of data records corresponding to a plurality of data intervals, wherein the plurality of data intervals are within the searchable interval;
generating an interval tree corresponding to the searchable interval, wherein the interval tree comprises a plurality of interval nodes arranged in a plurality of tiers, wherein the plurality of interval nodes correspond to a plurality of tree intervals that collectively span the searchable interval, and wherein the plurality of tree intervals comprise interval boundaries that are distinct among the plurality of tiers;
receiving a database query, wherein the database query comprises an interval query parameter;
identifying one or more responsive data records corresponding to the database query, wherein the one or more responsive data records are identified from the plurality of data records based on the interval tree and the interval query parameter;
retrieving the one or more responsive data records from the data storage device; and
generating a response to the database query based on the one or more responsive data records.

2. The method of claim 1, wherein:
the interval tree comprises a relational interval tree; and
the plurality of interval nodes comprise a plurality of fork nodes in the relational interval tree.

3. The method of claim 1, further comprising:
identifying a corresponding interval node for each data record of the plurality of data records, wherein the corresponding interval node for each data record is identified from the plurality of interval nodes in the interval tree; and
storing a plurality of interval node identifiers in the database, wherein the plurality of interval node identifiers indicate the corresponding interval node for each data record of the plurality of data records.

4. The method of claim 3, wherein identifying the one or more responsive data records corresponding to the database query comprises:
identifying a subset of interval nodes corresponding to the interval query parameter, wherein the subset of interval nodes are identified from the plurality of interval nodes in the interval tree;
identifying a subset of data records corresponding to the subset of interval nodes, wherein the subset of data records are identified from the plurality of data records based on the plurality of interval node identifiers; and
identifying the one or more responsive data records from the subset of data records based on the interval query parameter, wherein the one or more responsive data records correspond to one or more data intervals that match the interval query parameter.

5. The method of claim 1, wherein each tier of the interval tree comprises one or more interval nodes of the plurality of interval nodes, wherein the one or more interval nodes within each tier correspond to one or more tree intervals of a particular granularity that collectively span the searchable interval.

6. The method of claim 1, wherein generating the interval tree corresponding to the searchable interval comprises:
identifying the searchable interval;
identifying a tree granularity associated with the interval tree; and
generating the plurality of tiers of the interval tree, wherein each tier is generated based on a corresponding tier interval and a corresponding tier granularity, wherein:
the first tier is generated based on the searchable interval as the corresponding tier interval and the tree granularity as the corresponding tier granularity; and
each successive tier is generated by shifting the corresponding tier interval relative to a preceding tier and increasing the corresponding tier granularity relative to the preceding tier.

7. The method of claim 6, wherein generating the plurality of tiers of the interval tree comprises:
generating each successive tier of the interval tree until the corresponding tier granularity for a final tier equals or exceeds a size of the searchable interval.

8. The method of claim 6, wherein generating the plurality of tiers of the interval tree comprises:
shifting the corresponding tier interval of each successive tier relative to the preceding tier, wherein the corresponding tier interval of each successive tier is shifted by a fraction of the corresponding granularity of the preceding tier; and
increasing the corresponding tier granularity of each successive tier relative to the preceding tier, wherein the corresponding tier granularity of each successive tier is increased to a multiple of the corresponding tier granularity of the preceding tier.

9. The method of claim 8, wherein:
the corresponding tier interval of each successive tier is shifted by half of the corresponding granularity of the preceding tier; and
the corresponding tier granularity of each successive tier is increased to twice the corresponding tier granularity of the preceding tier.

10. The method of claim 8, wherein shifting the corresponding tier interval of each successive tier relative to the preceding tier comprises shifting a minimum boundary of the corresponding tier interval.

11. The method of claim 1, wherein the searchable interval comprises a time interval.

12. A non-transitory computer readable medium having program instructions stored therein, wherein the program instructions are executable by a computer system to perform operations comprising:
defining a searchable interval associated with a database stored on a data storage device, wherein the database is to store a plurality of data records corresponding to a plurality of data intervals, wherein the plurality of data intervals are within the searchable interval;
generating an interval tree corresponding to the searchable interval, wherein the interval tree comprises a plurality of interval nodes arranged in a plurality of tiers, wherein the plurality of interval nodes correspond to a plurality of tree intervals that collectively span the searchable interval, and wherein the plurality of tree intervals comprise interval boundaries that are distinct among the plurality of tiers;
receiving a database query, wherein the database query comprises an interval query parameter;
identifying one or more responsive data records corresponding to the database query, wherein the one or more responsive data records are identified from the plurality of data records based on the interval tree and the interval query parameter;
retrieving the one or more responsive data records from the data storage device; and
generating a response to the database query based on the one or more responsive data records.

13. A system, comprising:
a processing device;
a data storage device;
a database management engine stored on the data storage device, the database management engine executable by the processing device to:
define a searchable interval associated with a database stored on the data storage device, wherein the database is to store a plurality of data records corresponding to a plurality of data intervals, wherein the plurality of data intervals are within the searchable interval;
generate an interval tree corresponding to the searchable interval, wherein the interval tree comprises a plurality of interval nodes arranged in a plurality of tiers, wherein the plurality of interval nodes correspond to a plurality of tree intervals that collectively span the searchable interval, and wherein the plurality of tree intervals comprise interval boundaries that are distinct among the plurality of tiers;
receive a database query, wherein the database query comprises an interval query parameter;
identify one or more responsive data records corresponding to the database query, wherein the one or more responsive data records are identified from the plurality of data records based on the interval tree and the interval query parameter;
retrieve the one or more responsive data records from the data storage device; and
generate a response to the database query based on the one or more responsive data records.

14. The system of claim 13, wherein the database management engine is further executable by the processing device to:
identify a corresponding interval node for each data record of the plurality of data records, wherein the corresponding interval node for each data record is identified from the plurality of interval nodes in the interval tree; and
store a plurality of interval node identifiers in the database, wherein the plurality of interval node identifiers indicate the corresponding interval node for each data record of the plurality of data records.

15. The system of claim 14, wherein the database management engine executable by the processing device to identify the one or more responsive data records corresponding to the database query is further executable to:
identify a subset of interval nodes corresponding to the interval query parameter, wherein the subset of interval nodes are identified from the plurality of interval nodes in the interval tree;
identify a subset of data records corresponding to the subset of interval nodes, wherein the subset of data records are identified from the plurality of data records based on the plurality of interval node identifiers; and
identify the one or more responsive data records from the subset of data records based on the interval query parameter, wherein the one or more responsive data records correspond to one or more data intervals that match the interval query parameter.

16. The system of claim 13, wherein the database management engine executable by the processing device to generate the interval tree corresponding to the searchable interval is further executable to:
identify the searchable interval;
identify a tree granularity associated with the interval tree; and
generate the plurality of tiers of the interval tree, wherein each tier is generated based on a corresponding tier interval and a corresponding tier granularity, wherein:
the first tier is generated based on the searchable interval as the corresponding tier interval and the tree granularity as the corresponding tier granularity; and
each successive tier is generated by shifting the corresponding tier interval relative to a preceding tier and increasing the corresponding tier granularity relative to the preceding tier.

17. The system of claim 16, wherein the database management engine executable by the processing device to generate the plurality of tiers of the interval tree is further executable to:
generate each successive tier of the interval tree until the corresponding tier granularity for a final tier equals or exceeds a size of the searchable interval.

18. The system of claim 16, wherein the database management engine executable by the processing device to generate the plurality of tiers of the interval tree is further executable to:
shift the corresponding tier interval of each successive tier relative to the preceding tier, wherein the corresponding tier interval of each successive tier is shifted by a fraction of the corresponding granularity of the preceding tier; and
increase the corresponding tier granularity of each successive tier relative to the preceding tier, wherein the corresponding tier granularity of each successive tier is increased to a multiple of the corresponding tier granularity of the preceding tier.

19. The system of claim 18, wherein:
the corresponding tier interval of each successive tier is shifted by half of the corresponding granularity of the preceding tier; and
the corresponding tier granularity of each successive tier is increased to twice the corresponding tier granularity of the preceding tier.

20. The system of claim 18, wherein the database management engine executable by the processing device to shift the corresponding tier interval of each successive tier relative to the preceding tier is further executable to:
shift a minimum boundary of the corresponding tier interval.
